(19) United States
(12) Patent Application Publication
(10) Pub. No.: US 2019/0392693 A1
(43) Pub. Date: Dec. 26, 2019

(54) METHOD FOR DETERRING AN ARMED ASSAILANT IN A PUBLICLY OCCUPIED BUILDING

(71) Applicant: Richard Michael Franchi, (US)

(72) Inventor: Richard Michael Franchi, (US)

(21) Appl. No.: 16/015,373

(22) Filed: Jun. 22, 2018

(51) Int. Cl. G08B 15/00; G08B 15/02; F41H 9/06; F41H 9/04

(52) U.S. Cl. CPC G08B 15/001; G08B 15/02; F41H 9/04; F41H 9/06; G08B 15/008

(57) ABSTRACT

A method of deterring an armed assailant inside of a building which involves the steps of placing physically disabling devices inside a building occupied by people, placing video and audio devices inside a building, then connecting the devices to remote activation controllers, then recognizing an armed assailant by an occupant of the building with the ability to activate the physically disabling devices remotely, then activating the devices, then transmitting the audio and video media to law enforcement and building officials, then determining that the assault continues, then activating more physically disabling devices, then deactivating the devices.

### STATEMENT REGARDING FEDERALLY SPONSORED RESEARCH OR DEVELOPMENT

No federally sponsored research and development

### BACKGROUND OF THE INVENTION

There has been a rash of assaults by armed assailants at public schools throughout the United States carried out by people with rifles or other firearms which are lethal. Normally, there is no warning of the assault prior to the event. These attacks are performed in a stealthy manner in that the weapons are concealed until just before the attacks and only perceived by the victims when there is a shot fired. These events in large part occur in public schools where students and teachers are some of the most defenseless people in our society. The attacks frequently occur inside the school building where weapons are not allowed and where people are confined to small areas such as classrooms or cafeteria which have only one exit and entrance. Under these conditions an assailant can discharge the firearm without fear of being attacked by another person with a firearm or other substantial weapon because of the rules prohibiting weapons being carried inside of a school. This makes for and almost non-defensable situation because of the surprise and lack of ability to defend against such an attack. Further, because assailants can find areas where many people are concentrated there is likelihood anyone with a rifle or an automatic weapon will be able to shoot many people within a very short time end with no means of escape for the victims. There have been suggestions as to how to defend against armed assailants. Recently, there has been a suggestion that the teachers be armed with guns in the school. The purpose for arming the teachers is to have them draw their weapons and fire back at any armed assailant within their line of sight. Also, some schools have armed guards or police officers who are meant to keep order in the school amongst the students. They are much less likely to be able to defend the students and teachers by drawing their weapons and confronting an armed assailant. These persons are usually deployed in high schools because of the advanced age of the students and their ability to obtain firearms. The problem with armed police or security is that it is difficult to say that these defenders will be able to draw their weapon and fire at the assailant from a short distance because the weapon of choice for the defenders is a handgun which only works at short distances. Further, it is unknown whether an armed teacher with little training or experience will be able to perform under the stress of an armed attack. Further, in many situations the defenders do not have a line of sight view of the assailant nor do they know the actual location of the assailant. Other problems with armed police or teachers is that they are prone to block themselves in a room and protect the students in their classroom to hide from an unknown assailant who is actively firing a weapon and this prevents them from taking any action against the actions of the assailant who may be attacking students and faculty in other parts of the building. Other problems would be that the defenders could fire at innocent by-standers instead of the armed assailant. Needless to say arming a teacher a costly and difficult thing which maybe more harmful than helpful.

However, the reality of the situation is that teachers and security officers are the first responders to these instances and sneak attacks catch them off guard until it is too late to be of any substantial resistance to the assault. The local state police forces with substantial resources to confront the assailant usually take minutes or longer to respond to such a emergency through the 911 emergency system. By the time the police forces respond it is usually too late because of the speed of the assault.

This invention addresses all of the shortcomings that have previously been mentioned. The first responder, likely the school teachers, administration or security forces can deploy this system immediately upon learning of the assault by simply triggering a remote device. That takes away the defenders need to aggressively hunt for the assailant and limits their response to just pushing a button. The invention then allows for the deployment of a physically disabling device which is affixed to locations throughout the building and activated by remote triggering. The physically disabling device is meant to deter and distract and disrupt and delay an armed assault by affecting the senses of the assailant and inevitably their aim. These disabling devices are something an armed assailant would not be expecting as they do not expect any defense until the regular police force responds to the armed attack. The physically disabling device can be irritants to the eyes such as pepper spray, irritants to the nose such as sulfur gas, irritants to the throat such as cough smoke or blinding devices such as bright or flashing lights, opaque smoke or loud or obnoxious or concussive noises. The invention further allows for deployment of these physically disabling devices outside of the line of sight of the assailant leaving the deployer outside of the immediate danger zone. The invention further allows for deployment of the devices by one or more triggering devices which can be operated by different persons in different locations. The invention further allows for video and audio of the area where the assailant is located for transmission to school administration, security and law enforcement agencies at the time the physically disabling devices are deployed for identification of the assailant and his location. The invention further allows for notification to school administration, security and law enforcement of the disabling devices. The invention further allows for an initial deployment of one or a group of disabling devices and secondary deployment of other disabling devices after the situation has been assessed. The invention further allows for the disabling devices to be turned off by the responsible parties at any time, such as the police responders.

### SUMMARY OF THE INVENTION

The main aspect of this invention is concerned with a method of deterring an armed assault in a publicly occupied building by having the occupants or law enforcement remotely deploy physically disabling devices which are located inside the building and in the vicinity of the armed assailant to hinder the assailant without the need to confront him personally. Another aspect of this invention is concerned with the triggering of the physically disabling devices also triggering audio and video transmission of the location of the deployed disabling device and to transmit them to building administration and law enforcement. Another aspect of the invention is to activate the 911 system to notify police in law enforcement of the deployment of the physically disabling devices. Another aspect of the invention is to allow the building administration and law enforcement to turn off the physically disabling devices at anytime after their deployment.

The invention in this application involves the steps of placing physically disabling devices inside buildings in areas occupied by people, triggering the physically disabling devices by occupants of the building remotely during an armed assault, notifying building administration, security and law enforcement once the physically disabling devices bar deployed, transmitting video and audio of the location of the deployment to building officials, security and law enforcement during and after the devices are deployed, triggering secondary devices and turning off the deployed devices remotely by office administration, security or law enforcement.

### BRIEF DESCRIPTION OF THE SEVERAL VIEWS OF THE DRAWINGS

Not Applicable

### DETAILED DESCRIPTION OF THE INVENTION

The present invention compromises methods of using physically disabling devices to shock, irritate and confuse the senses of persons that are within a building occupied by people and deployed when an armed assault has begun and transmitting audio and video transmissions to law enforcement and building administration and further deploying secondary physically disabling devices and allowing law enforcement or building administration to terminate the physically disabling devices. The physically in disabling devices include pepper spray, strobe lights, smoke screens, sirens, obnoxious gas and concussive explosions.

### Example One

Where the physically disabling device is pepper spray it is placed in a hallway of the building with means for remotely deploying it by an occupant or occupants of the building during an armed assault, and it is placed in the vicinity of audio and video transmitting devices also with means for occupants to remotely activate the device. Next when an occupant with the ability to remotely trigger a physically disabling device recognizes an armed assault in the hallway he remotely triggers the device and deploys the pepper spray. Next building administration and law enforcement are notified of the armed assault. Next remotely activating and transmitting video and audio media of the assailant's location to the building officials and law enforcement. Next, terminating the physically disabling devices by building officials or law enforcement.

### Example 2

Several physically disabling devices are pepper spray and are placed in several positions in the hallways of the building with means for remotely deploying them by an occupant or occupants of the building during an armed assault, and they are placed in the vicinity of audio and video transmitting devices with means for the occupants to remotely activate the devices. Next when one or more occupants with the ability to remotely trigger the physically disabling devices recognize or sense an armed assault in the hallway he remotely triggers the device deploying the pepper spray. Next building administration and law enforcement are notified of the armed assault. Next remotely activating and transmitting video and audio media of the assailant's location to the building officials and law enforcement. Next, terminating the physically disabling devices by building officials or law enforcement.

### Example 3

Several physically disabling devices are combinations of pepper spray and flashing lights and are placed in several positions in the hallways of the building with means for remotely deploying them by an occupant or occupants of the building during an armed assault and the devices are placed in the vicinity of audio and video transmitting devices also with means for remotely activating them by the occupants with means for remotely detonating the physically disabling devices.

Next when occupants with the ability to remotely trigger the physically disabling devices recognize an armed assault in the hallway, the devices are triggered deploying the pepper spray and flashing lights. Next building administration and law enforcement are notified of the armed assault. Next, remotely activating and transmitting video and audio media of the assailant's location to the building officials and law enforcement. Next, terminating the physically disabling devices by building officials or law enforcement.

### Example 4

Several physically disabling devices are combinations of pepper spray and flashing lights and are placed in several positions in the hallways of the building with means for remotely deploying them by an occupant or occupants of the building during an armed assault and the devices are placed in the vicinity of audio and video transmitting devices also with means for remotely activating them by the occupants with means for remotely detonating the physically disabling devices. Next when an occupant with the ability to remotely trigger the physically disabling devices recognizes or senses an armed assault in the hallway he remotely triggers and deploys the pepper spray devices. Next building administration and law enforcement are notified of the armed assault. Next remotely activating and transmitting video and audio media of the assailant's location to the building officials and law enforcement. Next the building officials or law enforcement determining that the armed assault is still continuing. Next the law enforcement or building officials trigger and deploy flashing lights. Next terminating the physically disabling devices by building officials or law enforcement.

### Example 5

Several physically disabling devices are combinations of pepper spray, sulfur gas, cough smoke, flashing lights, opaque smoke, sirens and concussive explosions are placed in several positions in the hallways of the building with means for remotely deploying them by an occupant or occupants of the building during an armed assault and the devices are placed in the vicinity of audio and video transmitting devices also with means for remotely activating them by the occupants with means for remotely detonating the physically disabling devices. Next when an occupant with the ability to remotely trigger the debilitating devices recognizes an armed assault in the hallway he remotely triggers and deploys all of the devices. Next building administration and law enforcement are notified of the armed assault. Next, remotely activating and transmitting video and audio media of the assailant's location to the building officials and law enforcement. Next, terminating the physically disabling devices by building officials or law enforcement.

### Example 6

Several physically disabling devices are combinations of pepper spray, sulfur gas, cough smoke, flashing lights, opaque smoke, sirens and concussive explosions are placed in several positions in the hallways of the building with means for remotely deploying them by an occupant or occupants of the building during an armed assault and the devices are placed in the vicinity of audio and video transmitting devices with means for remotely activating them by occupants with means for the physically disabling devices. Next when an occupant with the ability to remotely trigger the physically disabling devices recognizes an armed assault in the hallway he remotely triggers the siren. Next transmitting video and audio media of the assailant's location to the building officials and law enforcement. Next the building officials or law enforcement determine that the armed assault is still continuing. Next the law enforcement or building officials trigger and deploy flashing lights. Next the building officials or law enforcement determine that the armed assault is still continuing. Next the law enforcement or building officials trigger and deploy sulfur gas. Next the building officials or law enforcement determine that the armed assault is still continuing. Next the law enforcement or building officials trigger and deploy cough smoke. Next the building officials or law enforcement determine that the armed assault is still continuing. Next the law enforcement or building officials trigger and deploy pepper spray. Next the building officials or law enforcement determine that the armed assault is still continuing. Next the law enforcement or building officials trigger and deploy opaque smoke. Next the building officials or law enforcement determine that the armed assault is still continuing. Next the law enforcement or building officials trigger and deploy concussive explosions. Next, terminating the physically disabling devices by building officials or law enforcement.

1. A method of deterring an armed assailant inside of a building comprising the steps of: placing a physically disabling device at a location, with means for remotely activating it by an occupant or occupants of the building, at a location inside the building; then recognizing an armed assault at the location by an occupant with the ability to remotely activate the physically disabling device at the location inside the building; then activating the physically disabling device by the occupant.

2. A method of deterring an armed assailant inside of a building comprising the steps of: placing a physically disabling device, with means for remotely activating it by an occupant or occupants of the building, at a location inside the building; then recognizing an armed assault at the location by an occupant with the ability to remotely activate the physically disabling device at the location inside the building; then activating the physically disabling device by the occupant, then deactivating the physically disabling device.

3. A method of deterring an armed assailant inside of a building comprising the steps of: placing a physically disabling device, with means for remotely activating it by an occupant or occupants of the building, at a location inside the building in the vicinity of audio and video transmitting devices also remotely started by the occupant or occupants with means for remotely activating the physically disabling device; then recognizing an armed assault at the location by an occupant with the ability to remotely activate the physically disabling device, then activating the physically disabling device by the occupant, then notifying building administration and law enforcement of the armed assault, transmitting video and audio media of the location to the building officials and law enforcement, then deactivating the physically disabling device.

4. The method of claim 1 in which the physically disabling device is selected from the group consisting pepper spray, sulfur gas, cough smoke, flashing lights, opaque smoke, sirens and concussive explosions.

5. The method of claim 2 in which the physically disabling device is selected from the group consisting pepper spray, sulfur gas, cough smoke, flashing lights, opaque smoke, sirens and concussive explosions.

6. The method of claim 3 in which the physically disabling device is selected from the group consisting pepper spray, sulfur gas, cough smoke, flashing lights, opaque smoke, sirens and concussive explosions.

7. A method of deterring an armed assailant at a location inside of a building comprising the steps of: placing a plurality of physically disabling devices, with means for remotely activating them by an occupant or occupants of the building, at a location inside the building; then recognizing an armed assault at the location by an occupant with the ability to remotely activate the physically disabling devices inside the building; then activating the physically disabling devices by the occupant, then deactivating the physically disabling device.

8. The method of claim 7 in which the physically disabling devices are selected from the group consisting pepper spray, sulfur gas, cough smoke, flashing lights, opaque smoke, sirens and concussive explosions.

9. A method of deterring an armed assailant at a location inside of a building comprising the steps of placing a plurality of physically disabling devices, with means for remotely activating them by an occupant or occupants of the building, at the location inside the building, then recognizing an armed assault by an occupant with the ability to remotely activate the physically disabling devices inside the building, then activating the physically disabling device by the occupant; then deactivating the physically disabling devices.

10. The method of claim 9 in which the physically disabling devices are selected from the group consisting pepper spray, sulfur gas, cough smoke, flashing lights, opaque smoke, sirens and concussive explosions.

11. A method of deterring an armed assailant at a location inside of a building comprising the steps of: placing a plurality of physically disabling devices, with means for remotely activating them by an occupant or occupants of the building at the location, inside the building, in the vicinity of audio and video transmitting devices with means for remotely activating them; then recognizing an armed assault at the location by an occupant with the ability to remotely activate the physically disabling device inside the building; then activating the physically disabling device by the occupant; then notifying building administration and law enforcement of the armed assault, transmitting video and audio media of the location to the building officials and law enforcement; then terminating the physically disabling device.

12. A method of deterring an armed assailant at a location inside of a building comprising the steps of: placing a plurality of different type physically disabling devices with means for remotely activating them by an occupant or occupants of the building, at a location inside a the building in the vicinity of audio and video transmitting devices with means for remotely activating the physically disabling device; then recognizing an armed assault at the location by an occupant with the ability to remotely activate the physically disabling devices inside a building; then activating some of the physically disabling devices by the occupant; then notifying building administration and law enforcement of the armed assault, transmitting video and audio media of the location to the building officials and law enforcement; then determining that the armed assault is continuing; then activating the remaining physically disabling devices; then terminating the physically disabling devices.

13. The method of claim 12 in which the physically disabling devices are selected from the group consisting pepper spray, sulfur gas, cough smoke, flashing lights, opaque smoke, sirens and concussive explosions.

14. The method of claim 1, wherein the location is a hallway of the building.

15. The method of claim 14, wherein the physically disabling device is pepper spray.
